(19) United States
(12) Patent Application Publication
(10) Pub. No.: US 2008/0260523 A1
(43) Pub. Date: Oct. 23, 2008

(54) GAS TURBINE ENGINE WITH INTEGRATED ABRADABLE SEAL

(76) Inventors: Ioannis Alvanos, West Springfield, MA (US); Bernard A. Andrews, Hamden, CT (US)

Correspondence Address: CARLSON, GASKEY & OLDS/PRATT & WHITNEY, 400 WEST MAPLE ROAD, SUITE 350, BIRMINGHAM, MI, 48009, US

(21) Appl. No.: 11/736,728

(22) Filed: Apr. 18, 2007

(51) Int. Cl. F16J 15/447; F16J 15/54

(52) U.S. Cl. 415/173.4; 277/303; 277/415

(57) ABSTRACT

An abradable land assembly for a gas turbine engine includes a mount portion and an open cell portion which is to be abraded. Both portions are formed integrally from a single piece of material.

### BACKGROUND OF THE INVENTION

This application relates to a gas turbine engine, wherein abradable seal material is formed integrally with its mount structure.

Gas turbine engines are known, and typically include a compression section receiving and compressing air. The compressed air is delivered downstream into a combustion section. The air is mixed with fuel in the combustion section and burned. Products of this combustion pass downstream over turbine rotors. The turbine rotors are driven to rotate, and create power.

The design of gas turbine engines includes a good deal of effort to reduce leakage in the turbine section. The turbine section typically includes a plurality of rotors mounting a plurality of turbine blades, and which are the portions driven to rotate by the products of combustion. Seals on these rotors rotate in close proximity to static sealing structures to reduce leakage of a pressurized fluid.

In one widely used type of seal, the rotors carry knife edge runners which are spaced to be closely spaced from abradable static lands. The abradable static lands are abraded away by the knife edged runners with contact, resulting in a close fitting interface and restriction to leakage.

In the art, the abradable structures are formed of honeycomb ribbon material mounted to an underlying mount or base structure. Some braze material is placed on a surface on the mount structure and the honeycomb ribbon is then brazed to this surface. As brazing occurs, the braze material wicks upwardly into the honeycomb ribbon cells. With this prior art structure, portions of the honeycomb material closest to the surface are no longer abradable as they are filled with the braze material. In some instances, the wicked portion is beyond manufacturing tolerance and must be repaired; this adds significant cost and time to the manufacturing process. The wicked portion also adds to the radial space requirements of the seal, which increases the overall size and weight of the engine.

### SUMMARY OF THE INVENTION

In a disclosed embodiment of this invention, an open cell structure of an abradable land is formed integrally with its mount structure. Thus, no brazing material is required. The open cell structure need not be honeycombed, as it can be any shape which can be machined in the abradable material. Thus, the open cell structure can have a shape specifically designed to maximize the resistance of flow, or provide any other design goal.

These and other features of the present invention can be best understood from the following specification and drawings, the following of which is a brief description.

### BRIEF DESCRIPTION OF THE DRAWINGS

FIG. 1A is a schematic view of a gas turbine engine.

FIG. 1B shows a feature of the prior art.

FIG. 1C is an enlarged view of a portion of FIG. 1B.

FIG. 1D shows another application for the present invention.

FIG. 1E shows yet another application for the present invention.

FIG. 2 shows an embodiment of the present invention.

FIG. 3A shows one alternative open cell shape.

FIG. 3B shows another alternative open cell shape.

FIG. 3C shows another alternative open cell shape.

FIG. 3D shows another alternative open cell shape.

FIG. 3E shows another alternative open cell shape.

FIG. 3F shows another alternative open cell shape.

FIG. 3G shows another alternative open cell shape.

FIG. 3H shows another alternative open cell shape.

FIG. 3I shows another alternative open cell shape.

FIG. 3J shows another alternative open cell shape.

FIG. 4A shows a cross-sectional view through the open cell structure.

FIG. 4B shows an alternative for the orientation of the cells.

### DETAILED DESCRIPTION OF THE PREFERRED EMBODIMENT

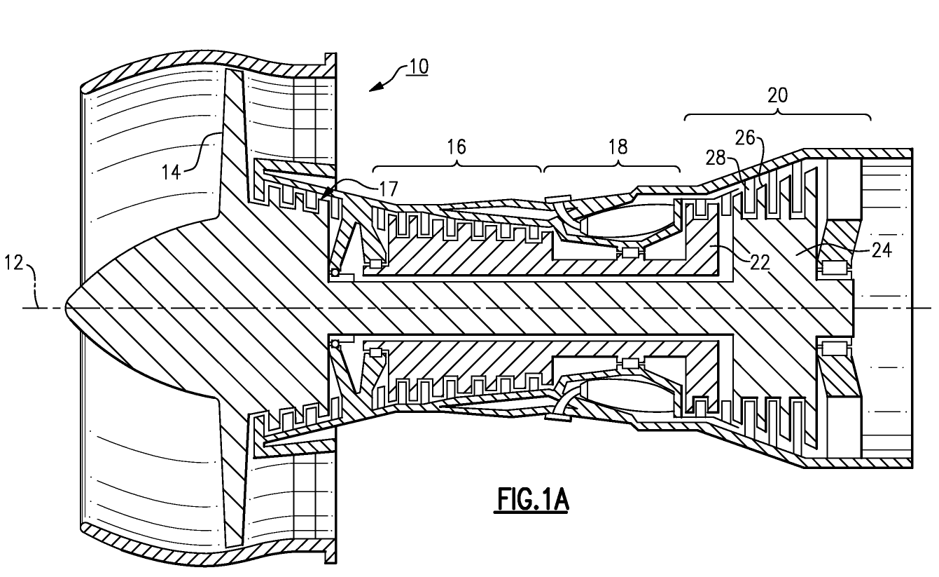

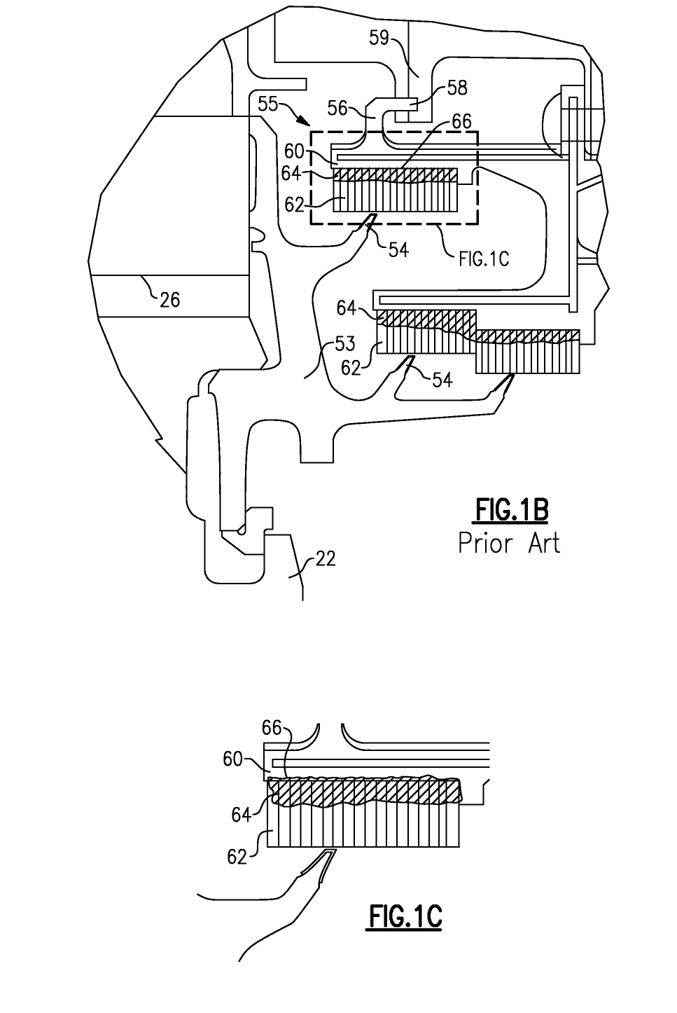

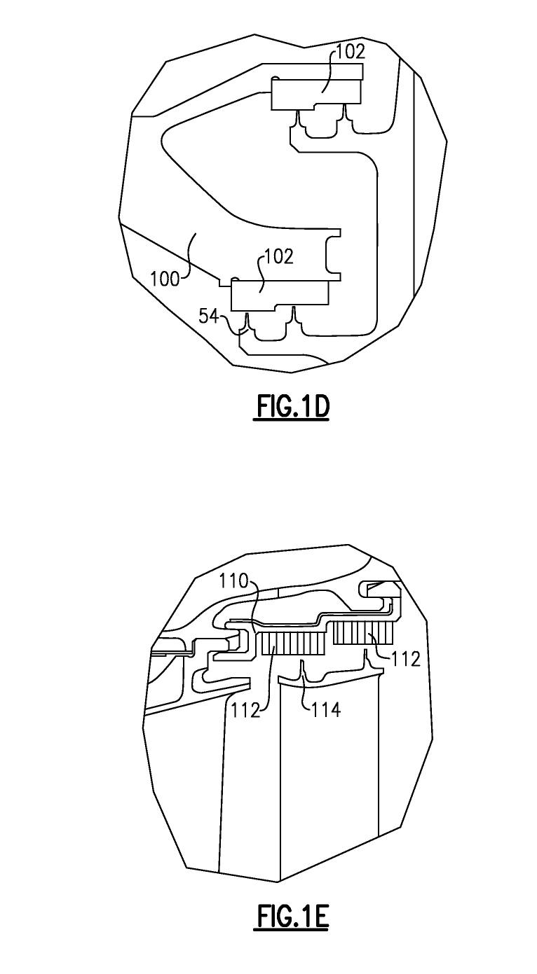

A gas turbine engine 10, such as a turbofan gas turbine engine, circumferentially disposed about an engine centerline, or axial centerline axis 12 is shown in FIG. 1A. The engine 10 includes a fan 14, compressors 16 and 17, a combustion section 18 and a turbine 20. As is well known in the art, air compressed in the compressor 16 is mixed with fuel which is burned in the combustion section 18 and expanded in turbine 20. The turbine 20 includes rotors 22 and 24, which rotate in response to the expansion, driving the compressors 16 and 17, and fan 14. The turbine 20 comprises alternating rows of rotary airfoils or blades 26 and static airfoils or vanes 28. This structure is shown somewhat schematically in FIG. 1. While one engine type is shown, this application extends to any gas turbine architecture, for any application.

As shown in FIG. 1B, the rotor blades 26 and rotor 22 (or 24) also carry a cover plate seal 53. The cover plate seal rotates, and carries knife edge runners 54 which rotate in close proximity to sealing lands 55. Typically, there are several circumferentially spaced sealing lands 55. Sealing lands 55 carry a mount structure 56 having tabs 58 to be received in a slot in static housing 59. Typically, there are a plurality of circumferentially spaced sealing lands, each including the mount structure 56. A mount surface or plate 60, which is part of mount structure 56, receives honeycomb ribbon material 62. The honeycomb ribbon material is formed of some abradable material. In one known land, a woven honeycomb shaped ribbon material formed of a nickel based alloy, such as Hastelloy X™ is utilized.

As shown in FIGS. 1B and 1C, brazing material 66 is placed on a face of the plate 60. This brazing material is used to secure the honeycomb ribbon material 62 to the plate 60. Powder braze material, paste braze material, or tape braze are used. The braze material is placed on the plate, the ribbon material is then placed on the braze material. The assembled mount structure 56 and ribbon 62 is then run through a furnace. The braze material melts and wicks into the open cells on the honeycomb in the ribbon 62. Thus, when the combined seal 55 leaves the furnace, the braze material will have filled the portion 64 of the cells adjacent to the plate 60. This portion will no longer be abradable, and thus will limit the effectiveness of the sealing structure 55 and increase the radial dimension requirements of the seal and the overall engine.

FIG. 1D shows another location 100 wherein the sealing structure 102 may be full hoop, and thus not utilizing a plurality of circumferentially spaced segments.

FIG. 1E shows another embodiment which is above the outer shroud of the rotating turbine blades. Again, there is a mount plate 110 and ribbon material 112 to be abraded by knife edged runners 114. It should be understood that while the invention is only illustrated in the FIG. 1C location, similar sealing lands can be provided under this invention for the FIG. 1D and FIG. 1E applications, or any other location that uses abradable seal material.

As shown in FIG. 2, in this application, the land 120 is integrally formed such that its mount structure 121 (including tab 122 and plate 124), and its open cell structure 126 are all integrally machined from a single piece of material. Thus, the brazing material is not utilized, and there will be no wicking of the brazing material into the open cell structure.

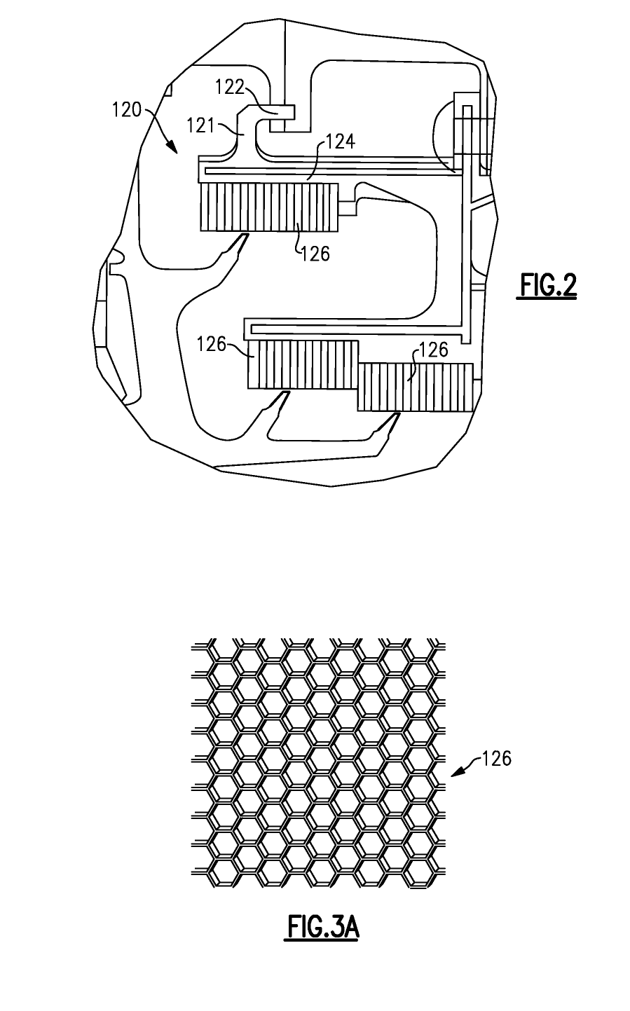

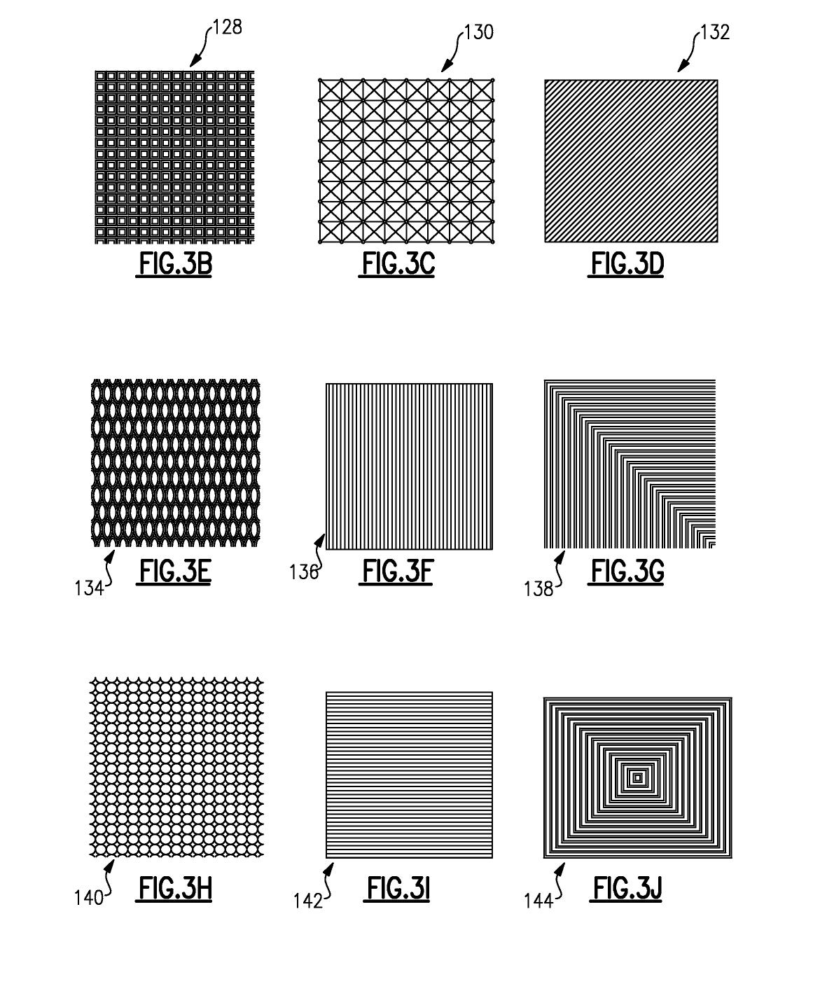

As shown in FIG. 3A, the open cell structure can be honeycomb shaped, as shown at 126, and as used in the prior art. However, the use of the inventive structure allows various other open cell shapes such as a square/rectangular shape 128 as shown in FIG. 3B. FIG. 3C shows triangular shapes 130. FIG. 3D shows an angled fin shape 132. FIG. 3E shows oval shapes 134. FIG. 3F shows vertical fin shapes 136. FIG. 3G shows combined angled fin shapes 138. FIG. 3H shows round shapes 140. FIG. 3I shows horizontal fin shapes 142. FIG. 3J shows multi-angled fin shapes 144. The exact nature of the open cell structure can be designed to provide particular flow restriction features. The material selected for the integral mount structure and abradable seal structure 120 is selected to be appropriate abradable material.

The shapes can be cut into the material by conventional machining, wire EDM machining, laser machining, conventional milling, chemical milling etc. A near-net cast part can be produced to possess the mount structure and to approximate the open cell structure to reduce material removal. The wall thickness is on the order of the conventional ribbon thickness to ensure abradability is not affected.

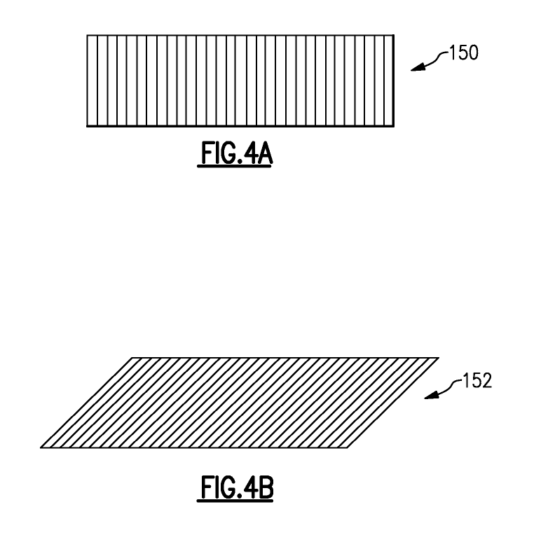

Further, since the open cell structure is machined into the material, the orientation of the cells in relation to a radial plane can vary, such as shown at 0° at FIG. 4A at 150, or at an angle such as 45° shown at 152 in FIG. 4B.

In addition, the term “plate” should not be interpreted to require a planar structure.

Several embodiments of the present invention are disclosed. However, a worker of ordinary skill in the art would recognize that certain modifications come within the scope of this invention. For that reason the following claims should be studied to determine the true scope and content of this invention.

What is claimed is:

1. An abradable sealing land assembly comprising:
an integral piece of abradable material, said integral piece of abradable material including mount structure, and an abradable surface for facing a rotating member, the abradable surface having an open cell structure.

2. The sealing land as set forth in claim 1, wherein said open cell structure is in a repeating pattern.

3. The sealing land as set forth in claim 1, wherein the mount structure includes a tab for mounting the mount structure to a fixed housing in a gas turbine engine.

4. The sealing land as set forth in claim 1, wherein the open cell structure includes a plurality of shapes arranged in an array.

5. The sealing land as set forth in claim 1, wherein the open cell structure includes a plurality of fin shapes with intermediate spaces.

6. The sealing land as set forth in claim 1, wherein the open cell structure extends along an angle towards a central axis of the mount structure.

7. The sealing land as set forth in claim 6, wherein the angle extends, radially inwardly perpendicular to the central axis.

8. The sealing land as set forth in claim 6, wherein the angle is non-perpendicular to the central axis.

9. The sealing land as set forth in claim 1, wherein the mount structure extends over a limited circumferential extent, and is used in combination with other abradable sealing lands when assembled.

10. A gas turbine engine comprising:
a compressor;
a combustor; and
a turbine section including a rotor, said rotor having a rotating knife edge runner structure which rotates adjacent a static abradable land, the abradable land formed of an integral piece of abradable material, said integral piece of abradable material including mount structure, and an abradable surface facing the rotor, the abradable surface having an open cell structure.

11. The gas turbine engine as set forth in claim 10, wherein said open cell structure is in a repeating pattern.

12. The gas turbine engine as set forth in claim 10, wherein the mount structure includes a tab mounting the mount structure to a fixed housing in the gas turbine engine.

13. The gas turbine engine as set forth in claim 10, wherein the open cell structure includes a plurality of shapes arranged in an array.

14. The gas turbine engine as set forth in claim 10, wherein the open cell structure includes a plurality of fin shapes with intermediate openings.

15. The gas turbine engine as set forth in claim 10, wherein the open cell structure extends along an angle towards a central axis of the engine.

16. The gas turbine engine as set forth in claim 15, wherein the angle extends radially inwardly perpendicular to the central axis.

17. The gas turbine engine as set forth in claim 15, wherein the angle is non-perpendicular to the central axis.

18. The gas turbine engine as set forth in claim 10, wherein the mount structure extends over a limited circumferential extent, and is used in combination with other abradable seal and mount combinations when assembled in a gas turbine engine.

19. A method of forming a sealing land comprising:
providing a single piece of abradable material, and forming mount structure and an open cell structure in the single piece of abradable material.

20. The method as set forth in claim 19, wherein the shape of the open cell structure is designed to restrict fluid flow of a gas turbine engine into which the seal assembly will be utilized.
